(19) United States
(12) Patent Application Publication
(10) Pub. No.: US 2019/0047127 A1
(43) Pub. Date: Feb. 14, 2019

(54) Chain Tool

(71) Applicant: BIB Creative Co., Ltd., Xiushui Township (TW)

(72) Inventor: Tomonari Ichikawa, Xiushui Township (TW)

(21) Appl. No.: 16/057,920

(22) Filed: Aug. 8, 2018

(30) Foreign Application Priority Data
Aug. 9, 2017 (TW) 106211726

(51) Int. Cl. B25B 27/00; B21L 21/00

(52) U.S. Cl. CPC B25B 27/0071; B21L 21/00

(57) ABSTRACT

A chain tool for disassembling a chain buckle connecting two ends of a chain includes a body having a contact portion curved along a linear direction conforming to the shape of a roller of the chain buckle, and an impact portion located oppositely, a blocking portion is formed on at least one of two opposite sides of the body relevant to the contact portion, each blocking portion and the contact portion extend in parallel to each other, and a groove is formed between the contact portion and each blocking portion; while the invention is in use, the contact portion abuts with the roller at an end of the chain-connecting tool, the blocking portion blocks a link plate at a side of the chain buckle, a user hits against the impact portion for displacing the link plates thereby disassembling the chain buckle, and then the grooves receive the displaced link plates.

### FIELD OF THE INVENTION

The present invention relates to a bicycle tool, and more particularly to a chain tool for disassembling a chain buckle of a chain.

### BACKGROUND OF THE INVENTION

As shown in FIG. 15 to FIG. 17, conventional chain buckles are two link plates 91 connecting between the two symmetrical ends of a roller chain 90, in which a pin 92 and a positioning hole 93 are formed on each link plate 91, and each positioning hole 93 includes a bigger radius portion 931 and a smaller radius portion 932. While the link plates 91 are being assembled at the ends of the roller chain 90, the pin 92 of each link plate 91 passes through a roller 95 at the corresponding end of the roller chain 90, and then through the bigger radius portion 931 of another link plate 91. Afterwards, while applying force in opposite directions to the ends of the roller chain 90 from one another, the pins 92 are shifted from the bigger radius portion 931 to the smaller radius portion 932 and fixed, thereby finally connecting the link plates 91 between the two ends of the roller chain 90.

However, while attempting to disassemble the link plates 92 from the ends of the roller chain 90, it is barely able to do so by hands. Referring to FIG. 17, as a result, a clamp-shaped hand tool 94 is commonly applied to clamp the two rollers 95 between the two link plates 91 for pulling the two rollers 95 to become closer and dislocating the link plates 91, thereby forcing the two pins 92 to shift from the smaller radius portions 932 to the bigger radius portions 931, so as to remove the pins 92 from the bigger radius portions 931 to separate the two ends of the roller chain 90 from each other.

However, the conventional hand tool 94 mentioned above is bulky and not easy to carry along, seldom people bring such a bulky hand tool while riding a bicycle. Consequently, once disassembling of the roller chain is needed during biking, it would be troubled without carrying such hand tool.

### SUMMARY OF THE INVENTION

Because conventional hand tools for disassembling chains are bulky and unlikely to be carried-on, problems such as having no hand tools available around while disassembling a chain are commonly encountered. Accordingly, the present invention achieves the effect of being easy to carry by effectively reducing the volume of the body by forming a shape that can be used to disassemble the chain buckles.

An aspect of the present invention is to provide a chain tool including a body having a contact portion and an impact portion opposite to the contact portion, the contact portion is in a curve-shape curved inwardly along a linear direction, a blocking portion is formed on at least one of two opposite sides of the body relevant to the contact portion, each blocking portion and the contact portion extend in parallel to each other, and a groove is formed between the contact portion and each blocking portion.

While the invention is in use, the contact portion abuts with the roller at an end of the chain-connecting tool, the blocking portion blocks a link plate located at a side of the chain buckle, and then a user hits against the impact portion in order to displace the link plates thereby disassembling the chain buckle, where the grooves receive those displaced link plates.

The main feature of the present invention is that the shapes being used for disassembling the chain buckle including the contact portion, the impact portion, each blocking portion, and each groove are formed within the body, so that the size of the body only needs to be slightly larger than the roller located at a side of the chain buckle. The body can be in a block shape, a stick shape, and the like, and can be significantly smaller than clamp-shape hand tools, so that the present invention can be easily carried by the user to be instantly reached while the user intends to disassemble the chain buckle between the ends of a chain.

### BRIEF DESCRIPTION OF THE DRAWINGS

FIG. 1 is a schematic diagram illustrating a chain buckle between two ends of a chain according to a first preferred embodiment of the present invention.

FIG. 2 is a perspective drawing illustrating the link plates of the chain buckle according to the first preferred embodiment of the present invention.

FIG. 3 is a perspective drawing illustrating the first preferred embodiment of the present invention.

FIG. 4 is a schematic diagram illustrating a contact portion abutted with a roller according to the first preferred embodiment of the present invention.

FIG. 5 is a schematic diagram illustrating a displacement of the link plates after the impact portion has encountered an impact according to the first preferred embodiment of the present invention.

FIG. 6 is a perspective drawing illustrating a second preferred embodiment of the present invention.

FIG. 7 is a perspective drawing illustrating a third preferred embodiment of the present invention.

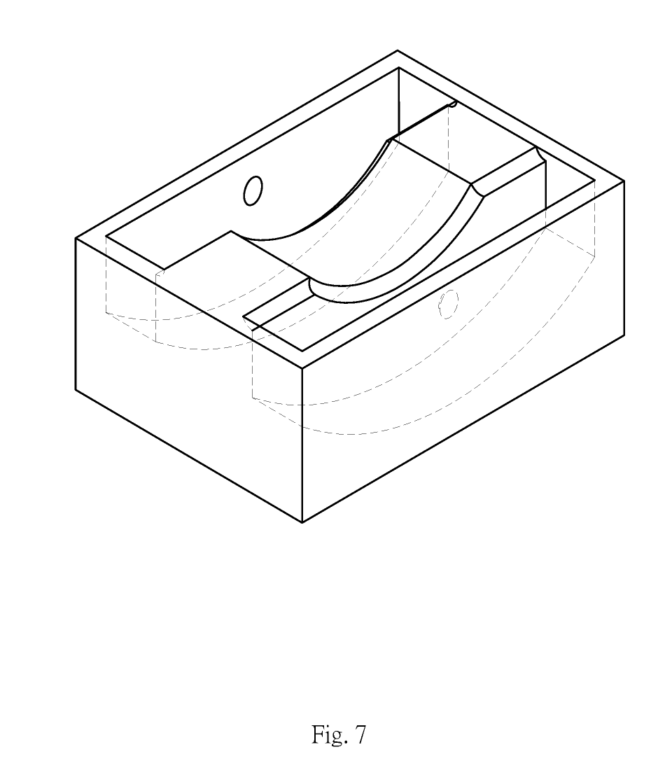

FIG. 8 is a perspective drawing illustrating a fourth preferred embodiment of the present invention.

FIG. 9 is an explosive drawing illustrating the fourth preferred embodiment of the present invention.

FIG. 10 is a planar view illustrating the fourth preferred embodiment of the present invention.

FIG. 11 is a schematic drawing illustrating the operation of the fourth preferred embodiment of the present invention.

FIG. 12 is another schematic drawing illustrating the operation of the fourth preferred embodiment of the present invention.

FIG. 13 is a perspective drawing illustrating a fifth preferred embodiment of the present invention.

FIG. 14 is a structural drawing illustrating a body of a sixth preferred embodiment of the present invention.

FIG. 15 is a perspective drawing illustrating a conventional chain buckle engaged with a chain.

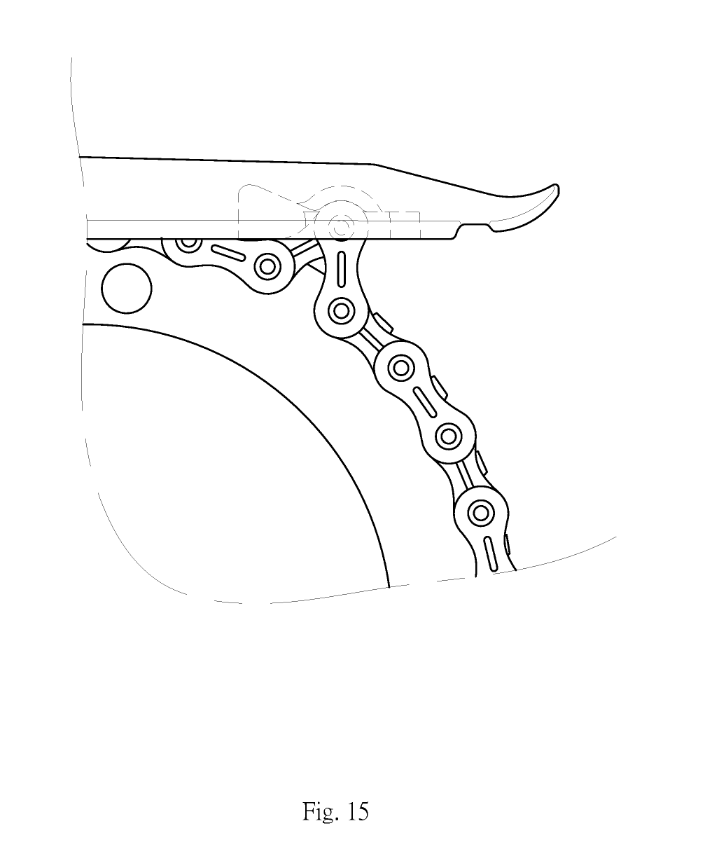

FIG. 16 is a planar view illustrating the conventional chain buckle engaged with the chain.

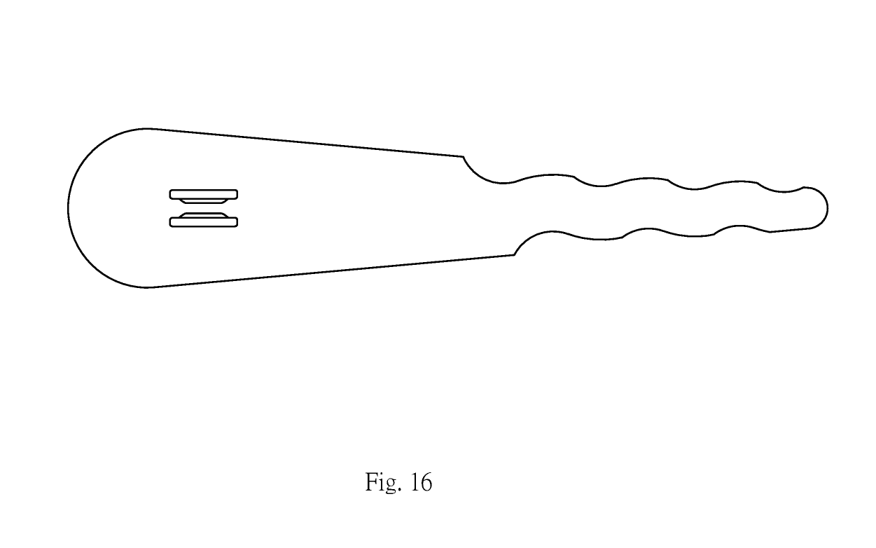

FIG. 17 is a schematic diagram illustrating a conventional chain being disassembled with a hand tool.

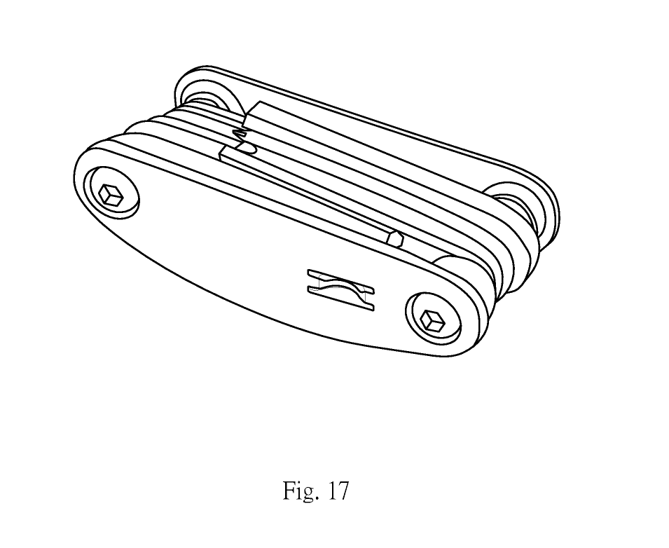

### DETAILED DESCRIPTION OF THE PREFERRED EMBODIMENTS

In order to make the technical features and practical effects of the present invention understood in detail, and the present invention implemented in accordance with the contents of the specification, the present invention is further described in detail below with reference to preferred embodiments shown in the drawings.

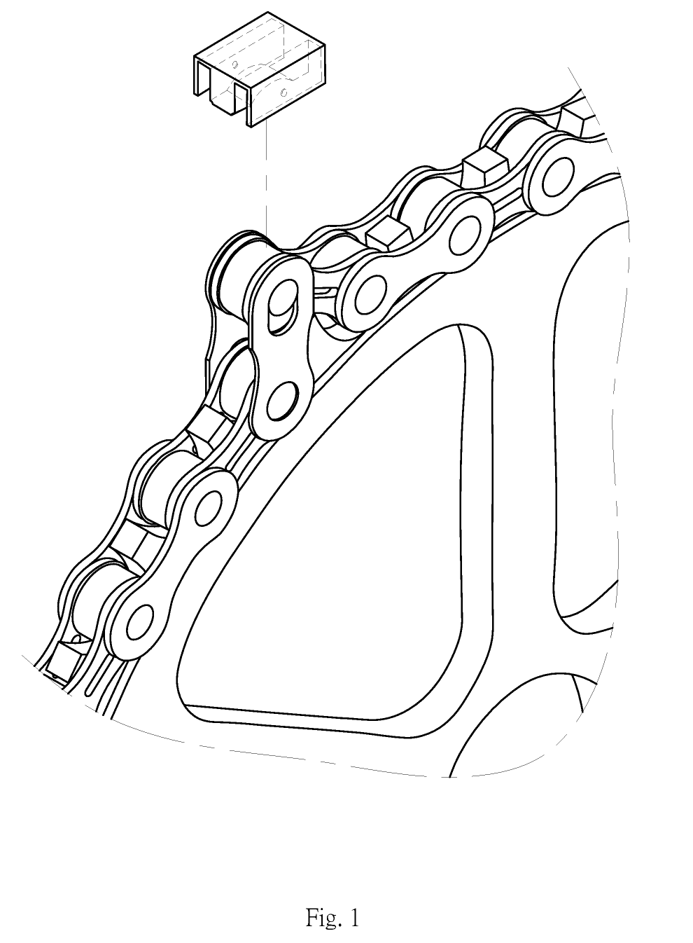

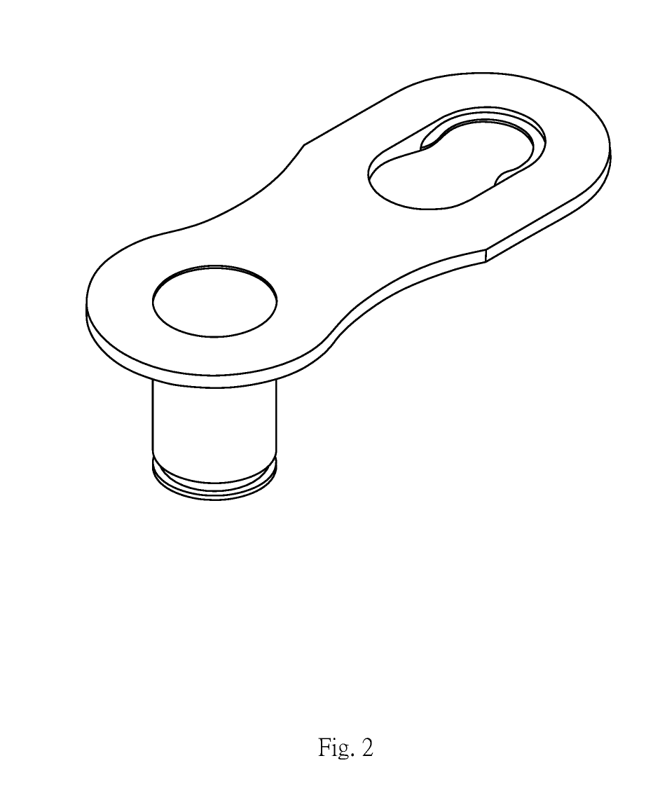

A chain tool is provided, with reference to FIG. 1 to FIG. 5 illustrating a preferred embodiment of the present invention, to disassemble a chain buckle 20 between two ends of a chain 10, in which the chain 10 is made up of plural link plates 11, rollers 12, and pins 13 connected in series. The chain buckle 20 has two link plates 21, each of them has a pin 22 and a fixing hole 23, and each fixing hole 23 has a bigger radius portion 231 and a smaller radius portion 232, the chain buckle 20 is the same with the chain buckle mentioned in the background section of the present disclosure, and same as the assembling processes, hence related descriptions are omitted here.

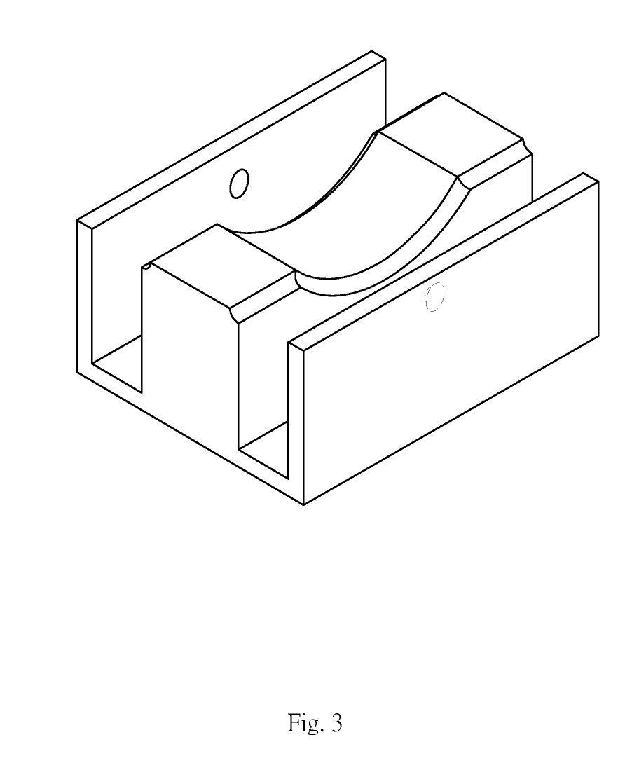

The chain tool of a first embodiment of the present invention, as shown in FIG. 1 and FIG. 3, has a body 30 being a rectangular block and having a contact portion 31 and an impact portion 32 formed on two opposite sides. The impact portion 32 and the contact portion 31 are back to back, and the contact portion 31 is in a curve-shape curved inwardly along a linear direction corresponding to the shape of the outer contour of the roller 12. Two blocking portions 33 are provided on two opposite sides of the body 30 relevant to the contact portion 31, and the extending directions of the blocking portions 33 and the contact portion 31 are parallel to each other. A groove 34 is formed between the contact portion 31 and each blocking portion 33, each groove 34 penetrates the body 30 along a direction parallel to the extending direction of the contact portion 31. A raised portion 331 is formed on a side of each blocking portion 33 facing the groove 34. The blocking portions 33 can be used to block the link plates 21 located at the sides of the chain buckle 20. While the aforementioned raised portion 331 has been formed on each blocking portion 33, the raised portions 331 are to be used to block the link plates 21. A concave filleted portion 311 for guiding is formed on where the contact portion 31 meets each groove 34.

In addition to the aforementioned first preferred embodiment that has the blocking portion 33 formed on both sides of the contact portion 31, in some embodiments, the blocking portion 33 may be formed on only one side of the body 30 relevant to the contact portion 31 such that there is only one groove 34 existing in the body 30, and such a configuration can still be used to disassemble the chain buckle 20.

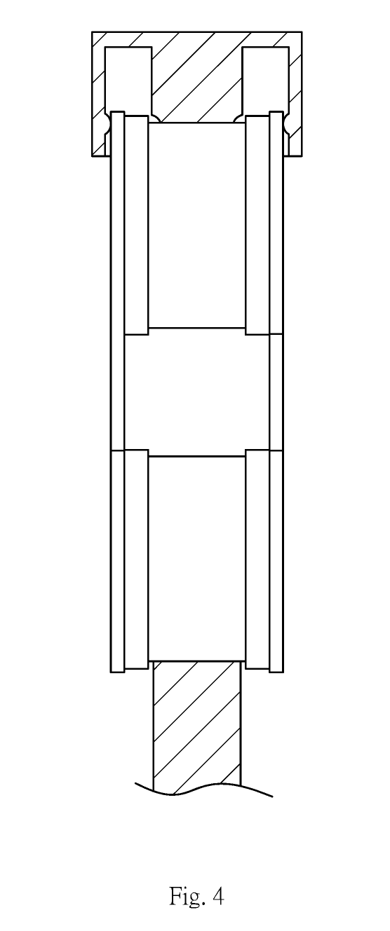

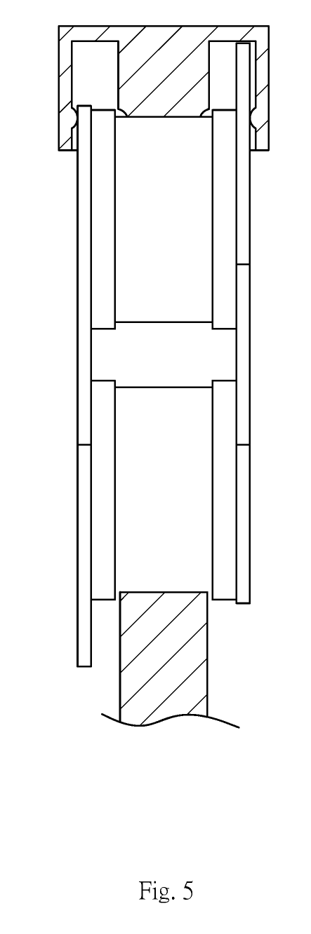

Referring to FIG. 4, while the chain tool of the aforementioned first embodiment is being used to disassemble the chain buckle 20, and the chain 10 is engaged with the periphery of a sprocket A, the user can first position the roller 12 which is mounted at an end of the chain buckle 20, for instance, position the roller 12 which is mounted at an end of the chain buckle 20 on the sprocket A, raise the chain buckle 20 up by hand to suspend the roller 12 at the other end of the chain buckle 20, and then align the contact portion 31 of the body 30 to the roller 12 at the other end of the chain buckle 20, and move the body 30 so that the two link plates 11 of the chain buckle 20 are respectively blocked by the raised portions 331 of the blocking portions 33, thereby aligning the contact portion 31 to the roller 12 at the other end of the chain buckle 20. Afterwards, the user can impact against the impact portion 32 by any carry-on items that can be used to impact against objects (ex. any rigid articles such as a flash light or a tea pot), or any rigid articles that can be easily reached (ex. rocks or irons along the road). As shown in FIG. 5, the link plates 21 of the chain buckle 20 are then dislocated due to the impact on the roller 12 abutted with the contact portion 31. Meanwhile, the dislocated link plate 21 is received by the groove 34 of the body 30, so as to disassemble the chain buckle 20.

According to the first preferred embodiment mentioned above, the advantage brought by the present invention is that the chain buckle 20 can be easily disassembled from the chain 10 by a simple impact against the body 30 by utilizing the interactions among the simple shapes of the contact portion 31, the impact portion 32, the blocking portions 33 and the grooves 34. Additionally, such impact occurred on the impact portion 32 can be made by any articles around. Besides, the size of the contact portion 31 and the size of the grooves 34 formed in the body 30 are close to the size of each roller 12 of the chain buckle 20 and the ends of the link plates 11, respectively, so that the size of the body 30 can be miniaturized to a size slightly bigger than the roller 12 at an end of the chain buckle 20. As a result, the present invention has a significantly smaller size comparing to the conventional clamp-shape hand tools and thereby being easier to carry along.

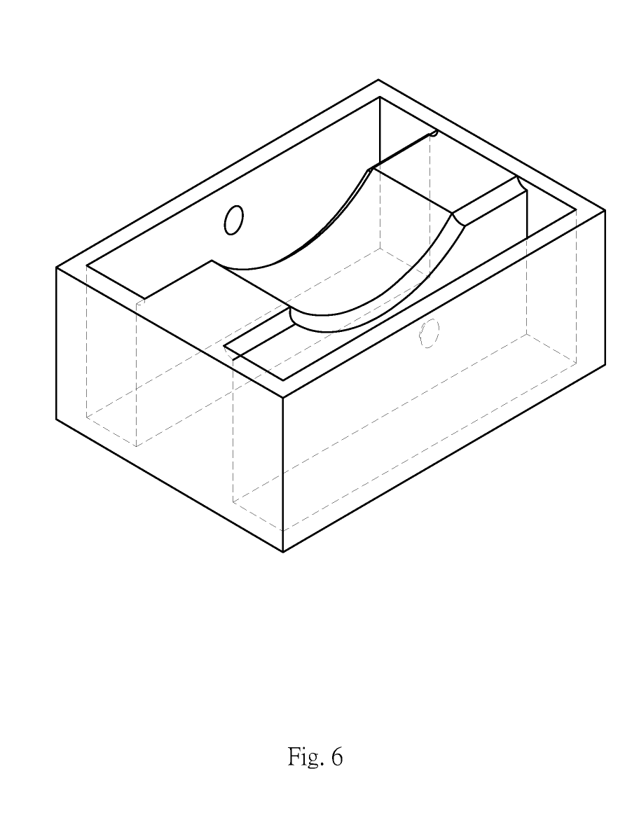

In addition to the first preferred embodiment above, in which the direction of grooves 34 penetrating the body 30 is in parallel with the extending direction of the contact portion 31, referring to FIG. 6 illustrating a second preferred embodiment of the present invention, the main difference from the first preferred embodiment is that the grooves 34 of the body 30 of the second preferred embodiment are penetrated through the body 30 in a direction perpendicular to the extending direction of the contact portion 31. Moreover, according to a third preferred embodiment shown in FIG. 3, the main difference from the first preferred embodiment is that grooves 34 of the body 30 of the third preferred embodiment is in a curve-shape curving inwardly and deeper than the inwardly-curved surface of the contact portion 31 of the body 30. Because the chain tools of the second and third embodiment operate in the same way as the first preferred embodiment does, and achieving similar effects, the detail mechanisms are omitted here.

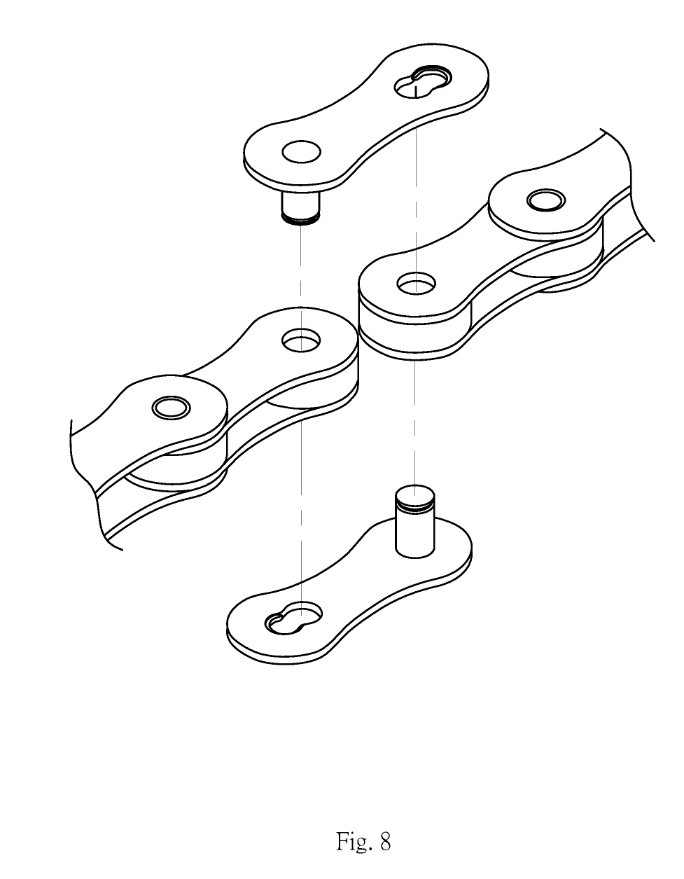

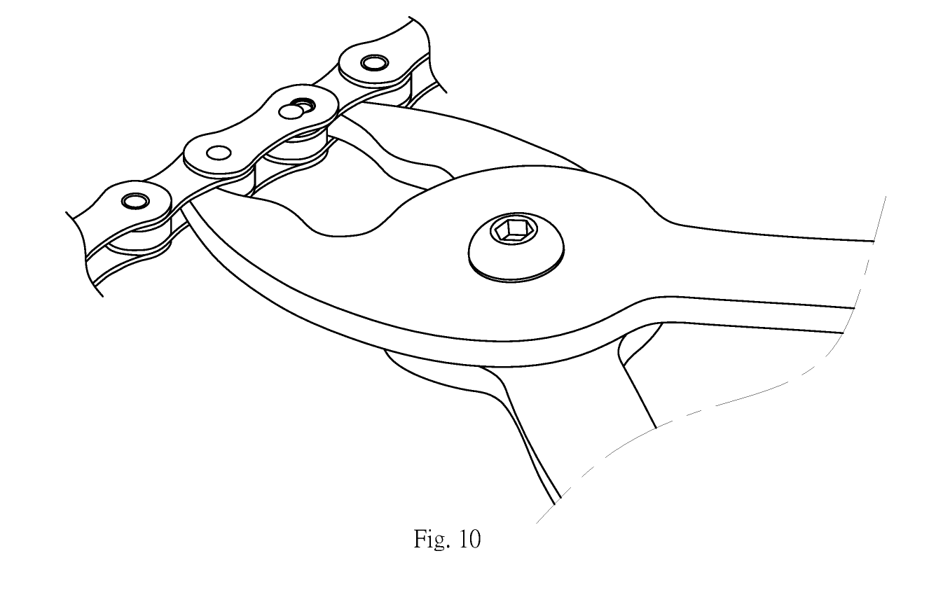

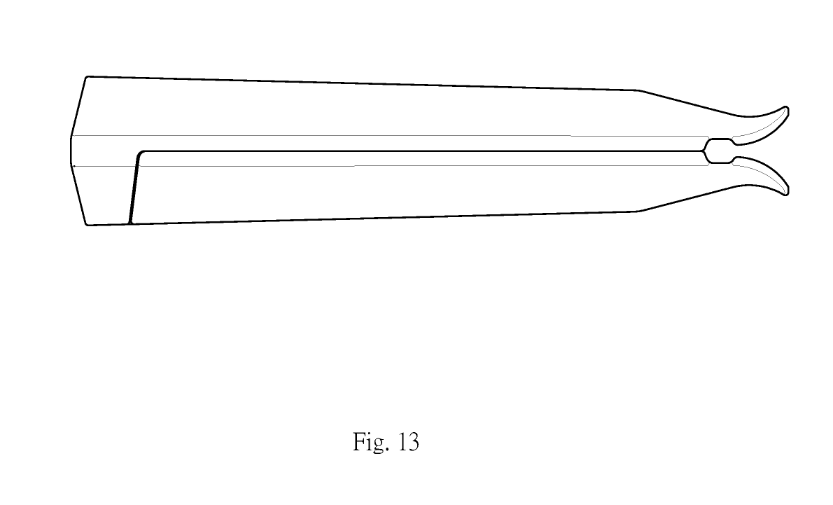

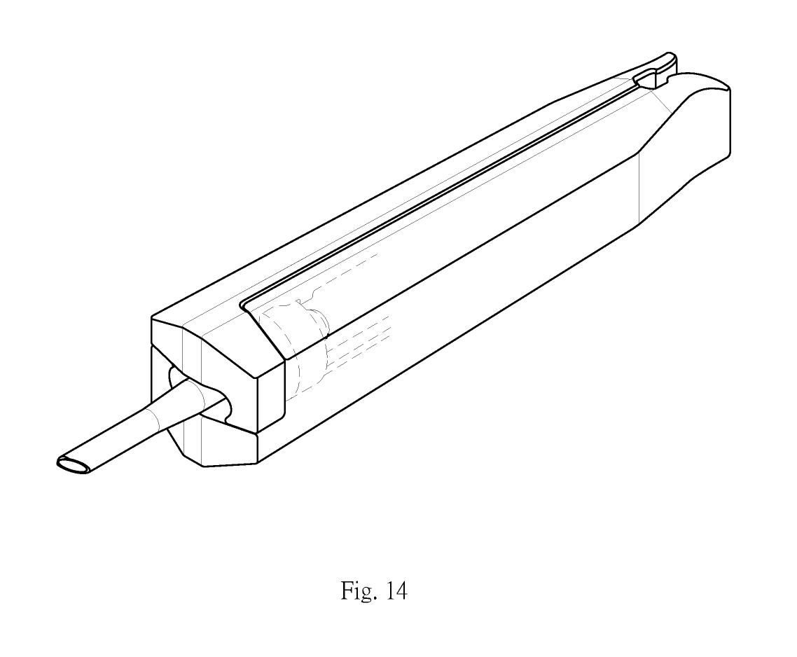

In addition to the first to third preferred embodiments, in which the bodies 30 are in a rectangular shape, the body 30 may also be in other shapes as shown in FIG. 8 to FIG. 12, illustrating a fourth preferred embodiment, FIG. 13, illustrating a fifth preferred embodiment, and FIG. 14, illustrating a six preferred embodiment.

Referring to FIG. 8 to FIG. 10 illustrating a fourth preferred embodiment of the present invention, in which the body 30 includes two tire spoons 40 combined together, each tire spoon 40 is a long block extending in along a straight line direction and has an opposite surface 401 facing one another, a spoon portion 41 is formed at an end of each tire spoon 40, a transverse groove 411 is formed at an end of each spoon structure 41, the inner surface of each transverse groove 411 is a turning surface, so that a polygonal hole B that can be fit with a tire valve is formed while the transverse grooves 411 of the tire spoons 40 have been placed together.

A containing recess 42 is formed on each opposite surface 401, a protruding block 421 protruding from the opposite surface 401 and a receiving notch 422 curving inwardly from the opposite surface 401 are formed along the peripheral edge of each containing recess 42, the protruding block 421 of each tire spoon 40 is embedded with the receiving notch 422 of one another tire spoon 40 for positioning. A quick-assembling recess 43 is formed inwardly from each opposite surface 401 and between each containing recess 42 and each spoon portion 41. A chain groove 44 is formed communicating each quick-assembling recess 43 and each containing recess 42. A protruding bar 423 is formed on the inner surface of each containing recess 42 and close to a side of the other end of each tire spoon 40. A penetrating groove 45 is formed on where each opposite surface 401 meets the other end of each tire spoon 40. An end of each penetrating groove 45 is communicated with the quick-assembling recess 43, and the other end of each penetrating groove 45 is penetrated through the other end of the tire spoon 40.

The fourth preferred embodiment further includes a tire repair element 50 that has a base 51 and a rod 52 passing through the center of the base 51, the base 51 is embedded within the two containing recesses 42, and is positioned between the two containing recesses 42 and close to the penetrating grooves 45 with the two protruding bars 423. The rod 52 is positioned within the space defined by the two combined containing recesses 42, and so does a tire cement 53. The fourth preferred embodiment is that the contact portion 31, the two blocking portions 33 and the two grooves 34 as introduced in the first preferred embodiment are formed at the inner surfaces of the quick-assembling recesses 43 of the tire spoons 40, and the impact portion 32 as introduced in the first preferred embodiment is formed on each tire spoon 40 opposite to the contact portion 31. Instead of forming the contact portion 31, the two blocking portions 33, and the two grooves 34 on the inner surfaces of each quick-assembling recesses 43 according to the fourth preferred embodiment, the contact portion 31, the two blocking portions 33, and the two grooves 34 can be formed directly on each opposite surface 401, as a result, the quick-assembling recess 43 is omitted.

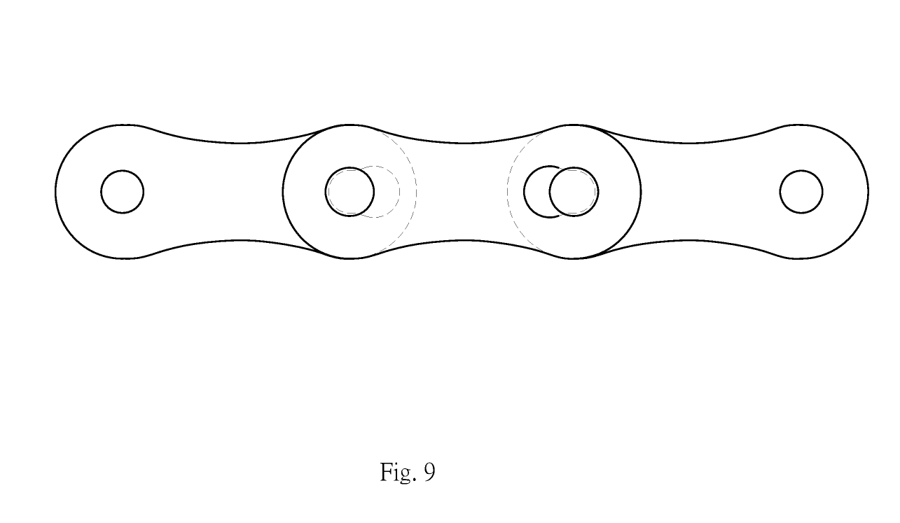

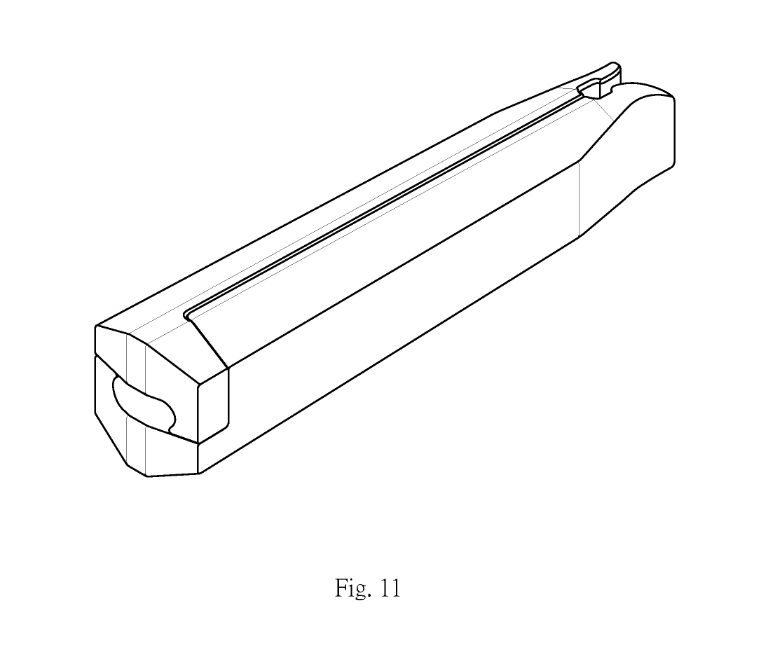

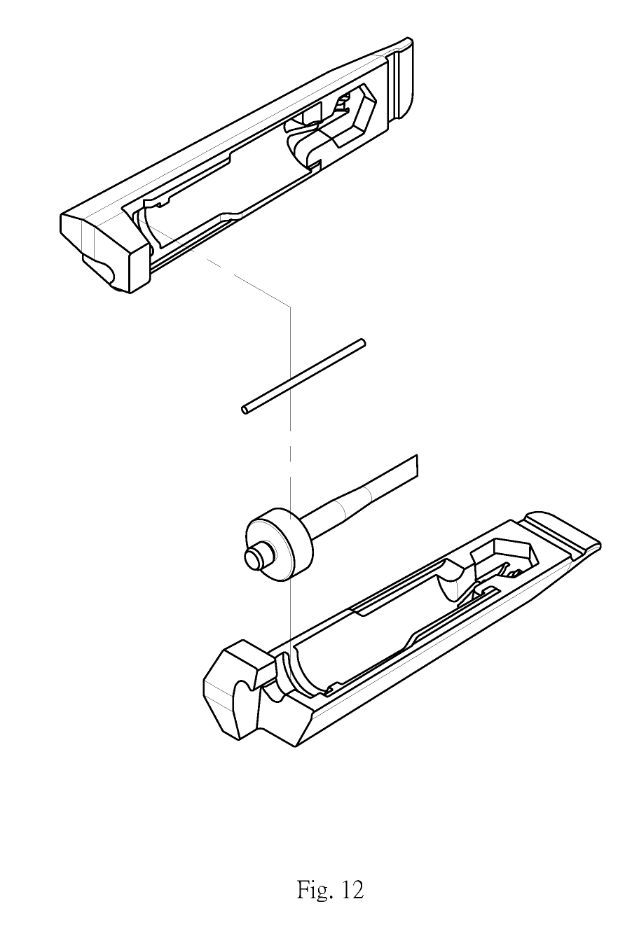

While operating the fourth preferred embodiment for disassembling chain buckles, referring to FIG. 9 and FIG. 11, one of the tire spoons 40 of the body 30 is used, in which the shapes of the contact portion 31, the two blocking portions 33, and the two grooves 34 of the tire spoon 40 are utilized to disassemble the chain buckle 20 of the chain 10 engaged around the sprocket A. Because the operating mechanism of the fourth preferred embodiment is same with the first preferred embodiment, the details are hereby omitted. While using the fourth preferred embodiment of the present invention to repair a tire, as shown in FIG. 9 and FIG. 12, firstly, the tire cement 53 is taken out from the spoon portions 41 after separating them, and after turning the tire repair element 50 into its opposite orientation, i.e. 180 degrees, the base 51 of the tire repair element 50 is placed back to the place where it was originally stored between the two containing recesses 42, and the rod 52 of the tire repair element 50 is then protruded out from the two penetrating grooves 45 while the two spoon portions 41 are combined together. Afterwards, the user may repair the tire using the rod 52 with the tire cement 53 by hands.

Referring to FIG. 13 illustrating a fifth preferred embodiment of the present invention, the body 30 is in a rod-like shape extending in a front-and-rear direction, the body 30 includes a handle 60 and a driving rod 61 extending from the handle 60 toward the front, the width of the driving rod 61 is tapered from the rear to the front. A left side of the driving rod 61 has plural first concave portions 611 spaced apart from each other and arranged along the front-and-rear direction, and a right side of the driving rod 61 has plural second concave portions 612 spaced apart from each other and arranged along the front-and-rear direction. The first concave portions 611 and the second concave portions 612 are arranged alternately along the front-and-rear direction. While inserting the driving rod 61 in between two rollers 12 of the chain buckle as shown in FIG. 1, the first concave portions 611 and the second concave portions 612 can pry the two rollers 12 outwardly so as to assemble the chain buckle 20.

The fifth preferred embodiment is that the contact portion 31, the two blocking portions 33, and the two grooves 34 as introduced in the first preferred embodiment are formed on the surface of the handle 60, and the impact portion 32 as introduced in the first preferred embodiment is formed on the handle 60 opposite to the contact portion 31. Because the operating mechanism of the fifth preferred embodiment is same with the first preferred embodiment, the details are hereby omitted.

FIG. 13 is a drawing illustrating a sixth embodiment of the present invention, in which the body 30 is a Swiss knife, and the contact portion 31, the two blocking portions 33, and the two grooves 34 as introduced in the first preferred embodiment are formed at a side of the body 30. The impact portions 32 as introduced in the first preferred embodiment is formed at the other side of the body 30 opposite to the contact portion 31. Because the operating mechanism of the sixth preferred embodiment is same with the first preferred embodiment, the details are hereby omitted.

What is claimed is:

1. A chain tool, comprising:
a body having a contact portion and an impact portion opposite to the contact portion, the contact portion is in a curve-shape curved inwardly along a linear direction, a blocking portion is formed on at least one of two opposite sides of the body relevant to the contact portion, each blocking portion and the contact portion extend in parallel to each other, and a groove is formed between the contact portion and each blocking portion.

2. The chain tool as claimed in claim 1, wherein each of the two opposite sides of the body relevant to the contact portion has the blocking portion formed thereon.

3. The chain tool as claimed in claim 1, wherein the body comprises two tire spoons combined together, each tire spoon is a long block extending in along a straight line direction and has an opposite surface facing one another, a containing recess is formed on a center of each opposite surface, a protruding block and a receiving notch are formed along a peripheral edge of each containing recess convexly and concavely respectively, the protruding block of each tire spoon is embedded with the receiving notch of one another tire spoon for positioning, an end of each tire spoon has a spoon portion formed thereon, and the contact portion, the impact portion, each blocking portion, and each groove are formed in one of the two tire spoons.

4. The chain tool as claimed in claim 3, wherein a transverse groove is formed at an end of each spoon structure and on the opposite surface, an inner surface of each transverse groove is a turning surface, so that a polygonal hole is formed while the transverse grooves of the tire spoons are combined together.

5. The chain tool as claimed in claim 3, wherein a protruding bar is formed on an inner surface of each containing recess and close to the other end of each tire spoon, a penetrating groove is formed on where each opposite surface meets the other end of each tire spoon, an end of each penetrating groove is communicated with a quick-assembling recess, and the other end of each penetrating groove is penetrated through the other end of the tire spoon, a tire repair element has a base and a rod passing through a center of the base, the base is embedded within the two containing recesses, and the base is positioned between the two containing recesses by the two protruding bars, and the rod is positioned within the two containing recesses.

6. The chain tool as claimed in claim 5, wherein the quick-assembling recess is formed inwardly from each opposite surface and between each containing recess and each spoon portion, a chain groove is formed communicating each quick-assembling recess and each containing recess, and the contact portion, the impact portion, each blocking portion, and each groove are formed on the inner surface of one of the tire spoons.

7. The chain tool as claimed in claim 1, wherein the body is in a rod-like shape extending in a front-and-rear direction, the body comprises a handle and a driving rod extending from the handle toward the front, the width of the driving rod is tapered from the rear to the front, a left side of the driving rod has plural first concave portions spaced apart from each other and arranged along the front-and-rear direction, and a right side of the driving rod has plural second concave portions spaced apart from each other and arranged along the front-and-rear direction, the first concave portions and the second concave portions are arranged alternately along the front-and-rear direction, the contact portion, the blocking portions, and the grooves are formed on the handle, and the impact portion is formed on the handle opposite to the contact portion.

8. The chain tool as claimed in claim 1, wherein the body is a Swiss knife.

9. The chain tool as claimed in claim 1, wherein a raised portion is formed on a side of each blocking portion facing the groove.

10. The chain tool as claimed in claim 1, wherein each groove penetrates through the body along a direction parallel to the extending direction of the contact portion.

11. The chain tool as claimed in claim 1, wherein each groove penetrates through the body in a direction perpendicular to the extending direction of the contact portion.
